(19) United States
(12) Patent Application Publication
(10) Pub. No.: US 2011/0286204 A1
(43) Pub. Date: Nov. 24, 2011

(54) Universal Ceiling Fan Uplight Kit

(76) Inventor: Jeffrey Lord, Belle Haven, VA (US)

(21) Appl. No.: 13/092,120

(22) Filed: Apr. 21, 2011

Related U.S. Application Data
(60) Provisional application No. 61/346,494, filed on May 20, 2010.

(51) Int. Cl. F21S 8/04

(52) U.S. Cl. 362/147

(57) ABSTRACT

A ceiling fan lighting device that incorporates upstanding lighting fixtures that spread illumination along a ceiling surface, improving ambiance within a room. The lighting device is a kit that affixes to and operates in coordination with a ceiling fan or an existing ceiling fan light fixture. The device may be used in conjunction with or independently from existing ceiling fan lights, depending upon user preference. When utilized independently, the upstanding lights eliminate the harsh lighting environment and spotlight effect of downward facing fixtures. The kit comprises a retaining ring mounted along the top surface of a fan motor housing that provides a base for a plurality of upstanding lights to project lighting onto a ceiling surface. The kit further comprises several installation embodiments, which offer alternate wiring architectures and configurations for the upstanding lights. The kit may be spliced into the ceiling fan wiring by itself, or alternatively wired in series or parallel with existing ceiling fan light fixture wiring.

### CROSS REFERENCE TO RELATED APPLICATION

This application claims the benefit of U.S. Provisional Application No. 61/346,494 filed on May 20, 2010, entitled “Universal Ceiling Fan Uplight Kit.”

### BACKGROUND OF THE INVENTION

1. Field of the Invention

The present invention relates to ceiling fan light fixtures. More specifically, the present invention pertains to universal ceiling fan lights that project light onto a ceiling surface from above a ceiling fan motor housing, providing a structure that uniquely illuminates a room setting.

The present invention is a modular lighting kit that can be wired into existing ceiling fan lights or operated independently. The lights comprise a retaining ring that houses the wiring and rests against the top surface of a ceiling fan motor. Protruding from the ring are a plurality of incandescent or fluorescent light bulbs that are aimed upward and outward from the ring. The motor housing of the fan provides shielding from direct lighting, while the majority of light is directed onto the ceiling for a warming atmosphere. Traditional ceiling fan lights utilize lamps that shine downward on a room and onto users, creating a spotlight effect and a harsh lighting environment. The present invention attempts to remedy this common problem by providing a device that creates warm, ambient lighting without downward facing glare. The present invention also provides a modular uplight installation kit for placing lights above an existing ceiling fan assembly.

2. Description of the Prior Art

Several devices have been disclosed and patented in the art that attempt to remedy common problems associated with ceiling fan lighting. Those that involve an uplight generally involve a large assembly that includes a lower light fixture or requires an entirely new ceiling fan assembly to be installed. Such devices include U.S. Published Patent Application No. 2002/0145867 to Tsuji and U.S. Pat. No. 5,440,459 to Chan, wherein two ceiling fan and light assemblies are described that include upward-standing and lower facing light fixtures surrounding a fan motor housing. Other patents that describe uplight ceiling fan fixtures are U.S. Pat. Nos. 6,247,894 to Moody and 6,309,083 to Larthrop. These two devices are particularly suited for low-ceiling installations, wherein space between the fan blades and the ceiling surface is limited to avoid interference with contents or individuals in a room. These two patents, along with the aforementioned set, describe entire ceiling fan installations that include a ceiling fan, motor, electrical connections and light fixtures.

The present invention is ideally used as a kit to upgrade existing ceiling fans and those ceiling fans that only include downward facing light sources. The kit comprises a base ring and upstanding light fixtures extending therefrom. The kit can be spliced into the wiring of an existing ceiling fan fixture to illuminate simultaneously with downward facing lights, or a switch can be included to independently operate the lower and upper light sources, or alternatively, the kit can be installed on a ceiling fan without a current light source and operate with a newly installed switch or only when the fan is operated. The kit is modular, with its setup is largely dependent upon the current type of ceiling fan installation, user preferences, and the desired installation complexity and cost desired by the installer and user.

The kit can also upgrade existing fan installations that do not include an illumination means. By installing the simple ring structure above the fan motor housing, the lights can be wired from the fixture to a separate switch, or spliced into existing ceiling fan controls. The type of control is dependent upon user preference, and may include independent or dependent control of the light with regard to the ceiling fan and existing ceiling fan light fixtures.

The types of bulbs included on the uplight kit assembly may be incandescent, fluorescent, or any other type that would be obvious to one skilled in the art. The goal is to provide a user with an upstanding light that is affixable to an existing ceiling fan and one that provides an improved ambiance within a room, without the harsh lighting effects associated with downward-facing light fixtures. The device further provides modularity and flexibility in the kit setup, with regard to existing fixtures and the ceiling fan controls. In light of these elements, the present invention sufficiently diverges in design elements from the disclosed prior art devices, and is adequately differentiated therefrom. Consequently it is clear that there is a need in the art for an improvement in existing ceiling fan light fixture installations. In this regard the instant invention substantially fulfills these needs.

### SUMMARY OF THE INVENTION

In view of the foregoing disadvantages inherent in the known types of ceiling fan lights now present in the prior art, the present invention provides a new ceiling fan lighting kit wherein the same can be utilized for providing convenience for the user when creating warm, ambient lighting within a room utilizing an uplight kit installable to an existing ceiling fan motor housing.

It is therefore an object of the present invention to provide a ceiling fan uplight kit that provides warm lighting within a room that is projected along the ceiling surface, and not downward onto users.

Another object of the present invention is to provide a ceiling fan uplight kit that is modular in nature, affixable to any ceiling fan without existing uplighting, and one that can work in conjunction with or independently from the fan or existing fixture controls.

Another object of the present invention is to provide an easily installable kit that requires only minor electrical installation knowledge, and one that is largely inexpensive when compared to entire ceiling fan-light fixture installations.

Yet another object of the present invention is to provide an uplight kit that may be controlled by a separate on/off switch, by a switch that incorporates an uplight operation setting, or a light fixture that works in conjunction with existing fan/light fixture controls.

It is therefore an object of the present invention to provide a new and improved ceiling fan uplight kit that has all of the advantages of the prior art and none of the disadvantages.

Other objects, features and advantages of the present invention will become apparent from the following detailed description taken in conjunction with the accompanying drawings.

BRIEF DESCRIPTIONS OF THE DRAWINGS

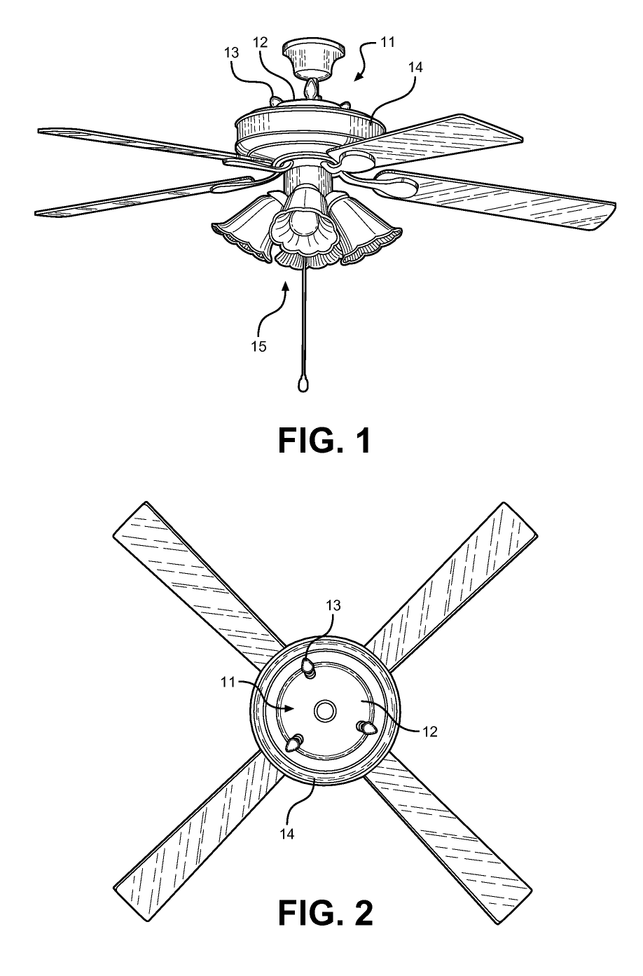

FIG. 1 shows a perspective view of a standard ceiling fan/light fixture combination, with the uplight kit installed above the ceiling fan motor.

FIG. 2 shows an overhead view of the uplight kit installation above a standard ceiling fan.

### DETAILED DESCRIPTION OF THE INVENTION

Referring now to FIG. 1, there is shown a perspective view of a standard ceiling fan with an existing downward-facing light fixture 15. An uplight kit 11 is affixed above the fan motor housing 14 and wired into the assembly. The uplight kit 11 comprises a base ring 12 with a plurality of light fixtures 13 extending therefrom. The light fixtures 13 extend upward and outward from the base ring 12 to project light along a ceiling surface. The base ring 12 is a circular base structure that accommodates the attachment structure of the ceiling fan at its center, and rests on the upper surface of the fan motor housing 14.

Referring now to FIG. 2, there is shown an overhead view of the uplight kit 11 attached to the upper surface of a ceiling fan motor housing 14. The uplight kit is a base ring 12 that rests flushly against the motor housing 14 upper surface and accommodates the fan attachment structure through its center. A plurality of light fixtures 13 around the circumference of the base ring 12 provide illumination means along the ceiling of a room, providing warm lighting and a pleasant ambiance.

The plurality of light fixtures around the base ring may vary in number and style, depending upon user and installer preference. It is not intended to limit the disclosed invention to a specific number of lights or a style of bulb. Alternatively, the bulbs may be housed internally within the base ring, which may be translucent to provide a shrouded illumination means for improved soothing light within a room. This is an alternate embodiment of the light fixtures and base ring device. A further embodiment of the base ring includes a universal plug mounted along the ring, whereby any light fixture may be plugged into the base ring and utilized as an uplight. In this embodiment, the base ring is spliced into the wiring of the ceiling fan, and electrical connectivity is provided for a third party light fixture plug. The base ring may or may not include its own lighting in this embodiment.

The uplight kit is provided to a consumer with a number different electrical setups. These include four distinct configurations that vary the control of the uplights with regard to the ceiling fan and existing light fixtures. In a first embodiment, and in its simplest form, the kit is installed on a ceiling fan that has no existing light fixture, and with no additional switches. The kit wiring is spliced directly in series with the ceiling fan wiring to provide illumination only when the fan is operational. In a second embodiment, an additional switch is provided to operate the uplights and the fan independently.

In a third embodiment, the kit is installed on a ceiling fan that has an existing downward facing light fixture. The wiring of this kit is installed in series with the existing light fixture switch, so that the uplight and downlight operate simultaneously or not at all. In a fourth and final embodiment, an additional switch is provided, and the kit is wired in parallel with the existing fan and downlight controls. This embodiment allows independent control of the uplight, fan, and existing downward facing light fixture. The degree of difficulty with regard to installation is increased, as well as associated cost in labor and material. However, the fourth embodiment offers maximum control over the light fixtures and the ceiling fan assembly. Dimmer switches or simple on/off electrical switches may be utilized for the control of each embodiment.

In use, an individual installs a preferred embodiment of the uplight kit on an existing ceiling fan installation. The ceiling fan may or may not include existing light fixturing, and the kit may or may not include extra light switch controls. Hot, neutral and ground wires from the kit are spliced according to the chosen embodiment, along with optional switches. Once installed, the uplight provides a warm lighting environment that does not shine light directly onto individuals or articles within a room, which can create glare or inhibit vision. The overhead, upward-directed lighting utilizes the reflection of light from the ceiling and the spread of the light along the ceiling surface to illuminate a room, providing a more inviting environment. In the alternate embodiment of the uplight fixture, the external light bulbs are moved internal to a translucent or semi-translucent base ring, further smoothing out the lighting in a room.

The device is intended as an add-on kit for existing fixtures and fan installations, or as a manufacturer-installed uplight device on a ceiling fan. The kit is intended to be inexpensive to manufacture and distribute, which reduces costs for both consumers and manufacturers. The exact number of light fixtures, included switches and design of the structure is not limited to the illustrations shown in FIGS. 1 and 2. Rather, these are embodiments of the disclosed invention, which provide an easy-to-install and inexpensive means for smoothing a light source within a room.

With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. An uplighting kit for installation on a ceiling fan, comprising:
a base ring with a hollow central region;
a plurality of uplight sources extending from said base ring;
said uplight sources include spliceable wiring connections housed within said base ring;
and said base ring placed on a top surface of said ceiling fan motor housing.

2. A device as in claim 1, wherein said wires are spliced in series with said ceiling fan, so that said uplight sources and fan are operate simultaneously or not at all.

3. A device as in claim 1, wherein said wires splice into a switch that is placed in parallel with said ceiling fan, so that said uplight sources and fan are operable independently.

4. A device as in claim 1, wherein:
said ceiling fan includes an existing, downward-facing light fixture;
said uplight source wires are spliced in series with said downward-facing light fixture, so that said uplights and said downward-facing light fixture operate simultaneously or not at all.

5. A device as in claim 1, wherein:
said ceiling fan includes an existing, downward-facing light fixture;
said uplight source wires are spliced into a switch that is placed in parallel with said downward-facing light fixture, so that said uplights and said downward-facing light fixture operate independently.

6. An uplighting kit for installation on a ceiling fan, comprising:
a base ring with a hollow central region;
said base ring is semi-translucent;
a plurality of uplight sources internally shrouded by said base ring;
said uplight sources include spliceable wiring connections housed within said base ring;
and said base ring placed on a top surface of said ceiling fan motor housing.

7. A device as in claim 6, wherein said wires are spliced in series with said ceiling fan, so that said uplight sources and fan are operate simultaneously or not at all.

8. A device as in claim 6, wherein said wires splice into a switch that is placed in parallel with said ceiling fan, so that said uplight sources and fan are operable independently.

9. A device as in claim 6, wherein:
said ceiling fan includes an existing, downward-facing light fixture;
said uplight source wires are spliced in series with said downward-facing light fixture, so that said uplights and said downward-facing light fixture operate simultaneously or not at all.

10. A device as in claim 6, wherein:
said ceiling fan includes an existing, downward-facing light fixture;
said uplight source wires are spliced into a switch that is placed in parallel with said downward-facing light fixture, so that said uplights and said downward-facing light fixture operate independently.

11. An uplighting kit for installation on a ceiling fan, comprising:
a base ring with a hollow central region;
spliceable wiring connections housed within said base ring and connected to a universal plug mounted along said base ring;
said base ring placed on a top surface of said ceiling fan motor housing.

12. A device as in claim 11, wherein said wires are spliced in series with said ceiling fan, so that said universal plug and fan are operate simultaneously or not at all.

13. A device as in claim 11, wherein said wires splice into a switch that is placed in parallel with said ceiling fan, so that said universal plug and fan are operable independently.

14. A device as in claim 11, wherein:
said ceiling fan includes an existing, downward-facing light fixture;
said wires are spliced in series with said downward-facing light fixture, so that said universal plug and said downward-facing light fixture operate simultaneously or not at all.

15. A device as in claim 11, wherein:
said ceiling fan includes an existing, downward-facing light fixture;
said wires are spliced into a switch that is placed in parallel with said downward-facing light fixture, so that said universal plug and said downward-facing light fixture operate independently.
